(19) United States
(12) Patent Application Publication
(10) Pub. No.: US 2021/0205933 A1
(43) Pub. Date: Jul. 8, 2021

(54) FLUX CORED BRAZING PREFORMS

(71) Applicant: Aleris Rolled Products Germany GmbH, Koblenz (DE)

(72) Inventors: Steven Kirkham, Koblenz (DE); Arne SCHLEGEL, Koblenz (DE); Bernd JACOBY, Koblenz (DE); Lawrence Stevenson KRAMER, Dayton, MD (US)

(73) Assignee: Aleris Rolled Products Germany GmbH, Koblenz (DE)

(21) Appl. No.: 17/250,070

(22) PCT Filed: May 15, 2019
(86) PCT No.: PCT/EP2019/062432

§ 371 Date: Nov. 18, 2020

(30) Foreign Application Priority Data
May 23, 2018 (EP) 18173738.8

(51) Int. Cl. B23K 35/02; B23K 35/28; B23K 35/362

(52) U.S. Cl. CPC B23K 35/0227; B23K 2101/32; B23K 35/362; B23K 35/286

(57) ABSTRACT

The invention relates to a shaped, small diameter brazing preform for brazing components to one another, the preform comprising a length of aluminium-based filler alloy wire having a continuous, uniform cavity in a centre of the preform along its length, and a brazing flux material retained within the cavity, and wherein the aluminium-based filler alloy has a composition comprising, in wt. %, Si 7-14%, Zn 0.5-%, Cu 1.0-2.0%, balance aluminium, and having a liquidus temperature in a range of 560° C. to 585° C.

### FIELD OF THE INVENTION

The invention relates to a shaped, small diameter brazing preform for brazing aluminium alloy components to one another, the shaped brazing preform comprising a length of aluminium-based filler alloy wire having a continuous, uniform cavity in a centre of the preform along its length and a brazing flux material retained within said cavity.

### BACKGROUND TO THE INVENTION

Heat exchangers and other similar equipment, such as condensers, evaporators and the like for use in car coolers, air conditioning systems, industrial cooling systems, etc. usually comprise a number of heat exchange plates or tubes (e.g. extruded or sheet material folded into the form of a tube) arranged in parallel between two headers, each tube joined at either end to one of the headers. Corrugated fins are disposed in an airflow clearance between adjacent heat exchange tubes and are brazed to the respective tubes. Many alternative arrangements are known in the art. The various components are commonly joined to each other by brazing. In a brazing process, a brazing filler metal or brazing filler alloy, or a composition producing a brazing alloy upon heating, is applied to at least one portion of the substrate to be brazed. To destroy and remove the aluminium oxide layer on the aluminium alloy and to protect it during brazing, a brazing flux material is often being used to enhance the brazeability of the brazing alloy prior to the brazing operation. Brazing is commonly effected by passing a heat exchanger unit through a tunnel furnace. Brazing can also be performed in a batch or semi-batch process.

The unit is heated to a brazing temperature between 595° C. and 615° C., soaked at an appropriate temperature until joints are created by capillary action and then cooled below the solidus of the filler metal. The melting point of the brazing filler alloy is lower than the melting point of the aluminium substrate or aluminium core sheet. The brazing filler alloy is commonly made of a 4xxx-series alloy comprising silicon in an amount in a range of 4% to 14% as its main alloying constituent.

Currently, the production of, for example, aluminium heat exchangers involves also using pre-formed rings, in the art also referred to as preforms. A preform is made of a filler alloy that is formed into a shape and applied to the joint for brazing. The preform include a brazing flux material coated or cored into the preform. Preferably, the brazing flux material cored into the preform may also escape through an opening, seam or channel along the length of the preform when heat is applied for the brazing operation. By allowing the brazing flux material to escape the core of the preform, the entire area of the joint may be pre-treated with brazing flux before the filler alloy melts.

### DESCRIPTION OF THE INVENTION

For any description of alloy compositions or preferred alloy compositions, all references to percentages are by weight percent unless otherwise indicated.

As used herein, the term “about” when used to describe a compositional range or amount of an alloying addition means that the actual amount of the alloying addition may vary from the nominal intended amount due to factors such as standard processing variations as understood by those skilled in the art.

The term “up to” and “up to about”, as employed herein, explicitly includes, but is not limited to, the possibility of zero weight-percent of the particular alloying component to which it refers. For example, up to 0.1% Cr may include an alloy having no Cr.

It is an object of the invention to provide a flux cored brazing preform that offers a broader processing window to enable the production of complex brazed components with differing relative mass and/or geometrical issues that would otherwise limit clad melting, wetting and joint formation.

This and other objects and further advantages are met or exceeded by the present invention providing a shaped, small diameter brazing preform for brazing components to one another, comprising a length of aluminium-based filler alloy wire having a continuous, uniform cavity in a centre of the preform along its length, and a brazing flux material retained within said cavity, the brazing flux material having a composition different than the aluminium alloy composition used for the shaped brazing preform, and wherein the aluminium-based filler alloy has a composition comprising, in wt. %,

Si 7% to 14%,

Zn 0.5% to 5%,

Cu 1.0% to 2.0%,

Fe up to 0.8%, preferably up to 0.5%,

Mn up to 0.3%, preferably up to 0.2%,

Mg up to 0.5%, preferably up to 0.3%,

Cr up to 0.1%,

V up to 0.1%,

Zr up to 0.1%,

Ti up to 0.2%,

balance aluminium and inevitable impurities, and having a liquidus temperature in the range of 560° C. to 585° C., and preferably of 570° C. to 585° C.

In accordance with the invention, it has been found that the flux cored brazing preform having a liquidus temperature in the range of 560° C. to 585° C. offers a broader processing window to enable the production of complex brazed components with differing thermal mass and/or geometrical issues that would otherwise limit clad melting, wetting and joint formation.

In the post-braze condition, the aluminium filler alloy used has a balanced corrosion potential despite an increased solute content, thus resulting in a good corrosion resistance.

The reduced liquidus temperature offers energy savings and allows a higher flexibility to braze components with different thermal mass.

The present invention helps ensure the production of a sound braze joint more efficiently than conventional brazing materials. Along with providing a very desirable brazing temperature range, the brazing preform of the present invention can be used with existing assemblies and processes.

The present flux cored brazing preform allows to work within the processing constraints of off-the-shelf brazing fluxing materials.

The Si, Zn and Cu are the key alloying elements in the aluminium-based filler alloy used in accordance with the invention. By keeping the presence of these alloying elements in the narrow ranges, the aluminium-based filler alloy provides a desirable balance of a reduced liquidus temperature allowing a brazing operation at reduced temperatures and having a good post-braze corrosion resistance. A reduced liquidus temperature allows a better brazing furnace temperature control resulting in component and process cost savings.

In an embodiment, the Si is at least about 9.0%, and preferably at least about 10.0%. A preferred upper-limit for the Si-content is about 13.0%.

In an embodiment, the Zn content is at least about 1.0%. In an embodiment, the Zn content is maximum about 3%, and preferably maximum about 2.0%, and more preferably about 1.7%.

In an embodiment, the Cu content is at least about 1.1%. In an embodiment, the Cu content is maximum about 1.75%, and preferably maximum about 1.7%.

Iron (Fe) is a common impurity in aluminium alloys and can be present up to about 0.8%. To avoid the formation of coarse primary silicon particles adversely affecting the brazing behaviour of the aluminium filler alloy, it is preferred to keep the Fe content to below about 0.5%, and more preferably to below about 0.3%. A too high Fe content may have also an adverse effect on the post-braze corrosion resistance of the aluminium filler alloy.

Manganese (Mn) can be present in the aluminium filler alloy up to about 0.3%, but is preferably present at a level of up to 0.2%, and more preferably up to 0.1%. A too high Mn content can adversely the clad flow during the brazing operation.

Magnesium (Mg) can be present in the aluminium filler alloy up to about 0.5%, but is preferably present at a level not exceeding about 0.3%, and more preferably not exceeding about 0.15%. Mg can form with Cu low melting constituent particles adversely affecting the brazing behaviour of the aluminium filler alloy. A too high Mg content may also interfere with the brazing flux material.

Cr can be present up to about 0.1%. Cr is preferentially avoided in the aluminium filler alloy. Preferably, it is tolerated up to 0.05%, and is preferably less than 0.04%, and more preferably less than 0.02%.

Further, each of vanadium (V) and zirconium (Zr) are preferentially avoided in the aluminium filler alloy. Such elements are costly and/or may form detrimental intermetallic particles in the aluminium filler alloy. Thus, the aluminium filler alloy generally includes not greater than about 0.1% V and not greater than about 0.1% Zr. In a preferred embodiment, the aluminium filler alloy includes V only up to 0.05%, and more preferably less than 0.02%. In a preferred embodiment, the aluminium filler alloy includes Zr only up to 0.05%, and more preferably less than 0.02%. Ti can be added to the aluminium filler alloy amongst others for grain refiner purposes during casting of the alloy ingots. The addition of Ti should not exceed about 0.2%, and preferably it should not exceed about 0.15%. A preferred lower limit for the Ti addition is about 0.005%. The Ti can be added as a sole element or with either boron or carbon as known in the art serving as a casting aid for grain size control.

In the aluminium-based filler alloy according to the invention, the balance is made by aluminium, and unavoidable impurities can be present each <0.05%, and the total of impurities is <0.2%.

The aluminium-based filler alloy employed in accordance with this invention is preferably silver (Ag) free. With “free”, it is meant that no purposeful addition of Ag is made to the chemical composition but due to impurities and/or leaking from contact with manufacturing equipment, trace quantities may nevertheless find their way into the alloy. In practice, this means that the amount present, if present, is up to about 0.005%, typically less than about 0.001%.

In an embodiment, the aluminium filler alloy further contains one or more wetting elements or elements modifying the surface tension of a molten Al—Si filler material. Preferably, the elements are selected from the group consisting of Be, Bi, Ce, La, Li, Na, Pb, Se, Sb, Sr, Th, and Y, and wherein the total amount of the wetting element(s) is in a range of about 0.005% to 0.8%. In a preferred embodiment, the upper-limit for the total amount of wetting element(s) is about 0.5%, and more preferably about 0.35%.

In an embodiment, the element Bi is selected from the defined group of wetting elements and is in a range of about 0.01% to 0.8%, and preferably in a range of about 0.01% to 0.5%, and more preferably 0.01% to 0.35%, as being the most efficient wetting element for this purpose in this alloy system during a brazing operation.

In an embodiment, the aluminium alloy has a composition, in wt. %, consisting of: Si 7% to 14%, Zn 0.5% to 5%, Cu 1.0% to 2.0%, Fe up to 0.8%, Mn up to 0.3%, Mg up to 0.5%, Cr up to 0.1%, V up to 0.1%, Zr up to 0.1%, Ti up to 0.2%, balance aluminium and inevitable impurities, and with preferred narrower compositional ranges as herein described and claimed.

The aluminium-based filler allow wire has a first side and a second side. In an embodiment, the aluminium-based filler alloy employed in the shaped brazing preform is a bare product, meaning that on either side, first and second side, it is devoid of any metallic layer(s) covering substantial parts of said product.

In an embodiment, the brazing flux material has an active temperature below the liquidus temperature of the aluminium-based filler alloy.

The brazing flux material employed in the shaped brazing preform according to the present invention may be chloride comprising, and preferably comprises fluoride. Preferably, the brazing flux material is solid at room temperature. The brazing flux material may comprise a mixture of one or more flux compounds and/or one or more flux-producing compounds. The following compounds can be mentioned as examples of fluoride comprising flux compounds: potassium fluoride (KF), aluminum fluoride (AlF₃), caesium fluoride (CsF), rubidium fluoride (RbF), lithium fluoride (LiF), sodium fluoride (NaF), and calcium fluoride (CaF₂). Potassium fluoroaluminates such as potassium tetrafluoroaluminate (KAlF₄), potassium pentafluoroaluminate (K₂AlF₅, K₂AlF₅.H₂O), and potassium hexafluoroaluminate (K₃AlF₆).

The brazing flux material employed in the present invention comprises at least one flux or flux-producing compound. It may comprise mixtures of the above-mentioned examples of flux and flux-producing compounds. In one embodiment, potassium fluoroaluminate(s) or compound(s) producing potassium fluoroaluminates, or mixtures thereof, are used. As examples of commercially available potassium fluoroaluminate comprising brazing flux materials can be mentioned: Nocolok® and Nocolok Sil® (ex Solvay Chemicals), and modifications thereof.

On a less preferred basis, the brazing flux material is contained within the cavity of the shaped brazing preform together with a binder, for example, a polymeric, for example, a propylene carbonate binder or a binder in the form of aqueous emulsion which burns-off during the heat-up cycle of a brazing operation.

The shaped brazing preform is made from a body or wire of an aluminium-based filler alloy according to this invention for forming the sides and outer-surface of the shaped brazing preform and having a continuous, substantially uniform cavity in its centre along its length, and wherein said cavity purposively retains a brazing flux material.

The body can be made by, for example, roll-forming technology using a plurality of rollers in one or more roll-forming steps from a strip or sheet material and filled with the brazing flux material as known in the art. The aluminium-based filler alloy strip may be formed or bowed into a brazing wire having a cross section of any desired shape and size. For example, the aluminium-based filler alloy sheet may be rolled about its longitudinal axis in a substantially circular manner to form a wire.

Once rolled, a length of the wire may be shaped, twisted or molded into various shapes, for example, adapting a configuration that is complementary to the various angles and sizes of the surfaces to be brazed. In specific embodiments, the wire can be formed into braze rings or helical loops having a circular cross-section.

In an embodiment, the brazing flux material is 10% to 40% by weight of the brazing preform, and preferably 10% to 30%.

In an embodiment, the shaped brazing preform has a cross-sectional diameter of up to about 4 mm, and preferably of up to about 3.5 mm. A preferred lower limit for the cross-sectional diameter of the shaped brazing preform is about 0.8 mm.

In a further aspect of the invention, it relates to a method of joining by means of brazing using an aluminium alloy brazing filler metal to form a joint between at least two base metals, preferably at least one being a pipe or tube of a heat exchanger, comprising the steps of: (a) preparing at least two base metals to be joined by brazing; (b) providing an aluminium filler alloy as herein defined having a liquidus temperature in a range of 560° C. to 585° C., and preferably 570° C. to 585° C.; (c) providing a brazing flux material, if required; (d) heating at least the joint portion of the base metals with a heating cycle, for example by induction-heating, laser heating, resistance heating, furnace or a flame; (e) joining the at least two base metals with a brazing technique using the aluminium filler alloy and the brazing flux material to form the joint in a joined assembly of the at least two base metals; and (f) cooling of the joined assembly to ambient temperature and where applicable remove excess brazing flux material.

In an embodiment of the method, the aluminium filler alloy filler is provided as a continuous length of wire having a chemical composition as herein defined and claimed, and preferably is a shaped brazing preform having the brazing flux material in the core of the wire.

In another embodiment of the method, the aluminium filler alloy is provided as a continuous length of solid wire having a chemical composition as herein defined and claimed, and wherein the brazing flux material is applied separately onto the outside of the wire prior to joining via brazing. The aluminium filler alloy can be in the form of filler rings made from drawn wire. In another example, the aluminium filler alloy is produced in sheet form and can be used as filler shim. The shim material can have a thickness anywhere from a few microns to a millimetre, depending on the application.

In a further aspect of the invention the shaped brazing preform is used to braze a pipe or tube of a heat exchanger or compressor, the heat exchanger being used within a final product of at least one of a refrigerator, an air conditioner, a radiator, a furnace, an automobile heat exchanger, and the like.

The invention shall also be described with reference to the appended figures.

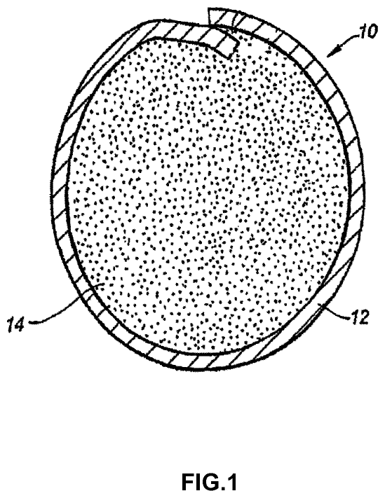

FIG. 1 shows a cross-sectional view of the shaped, small cross-sectional diameter brazing preform 10 according to this invention. The shaped brazing preform 10 is made from a wire 12 or body of an aluminium-based filler alloy defining an encasing perimeter that extends around the flux material 14. The wire 12 having a continuous, substantially uniform, cavity in its centre along its length, and wherein the cavity purposively retains a brazing flux material 14, for example a Nocolok®-based flux.

The flux-cored brazing preform can have any desired shape, such as a circle, flattened circle, oval, rectangular or a generally triangle shape.

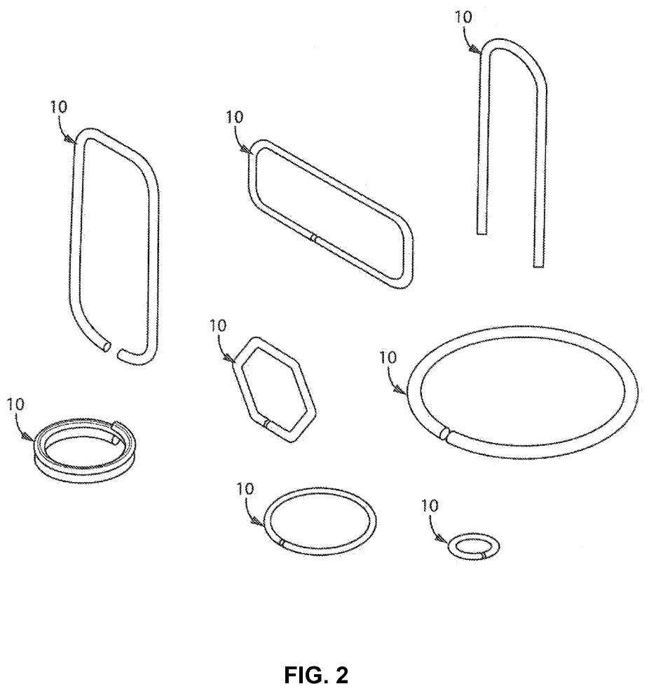

FIG. 2 shows various preformed, quasi-circular shapes made from the shaped, small diameter brazing preform 10 of FIG. 1. In further embodiments of the invention, the preform 12 is formed into a wire, strip, ring or preformed shapes.

Having now fully described the invention, it will be apparent to one of ordinary skill in the art that many changes and modifications can be made without departing from the spirit or scope of the invention as herein described.

1. A shaped, small diameter brazing preform for brazing components to one another, comprising a length of aluminium-based filler alloy wire having a continuous, uniform cavity in a centre of the preform along its length, and a brazing flux material retained within the cavity, and wherein the aluminium-based filler alloy has a composition comprising, in wt. %,
Si 7% to 14%,
Zn 0.5% to 5%,
Cu 1.0% to 2.0%,
balance aluminium and inevitable impurities, and having a liquidus temperature in the range of 560° C. to 585° C.

2. The shaped brazing preform according to claim 1, wherein the aluminium-based filler alloy has a composition comprising, in wt. %,
Si 7% to 14%,
Zn 0.5% to 5%,
Cu 1.0% to 2.0%,
Fe up to 0.8%,
Mn up to 0.3%,
Mg up to 0.5%,
Cr up to 0.1%,
V up to 0.1%,
Zr up to 0.1%,
Ti up to 0.2%,
balance aluminium and inevitable impurities.

3. The shaped brazing preform according to claim 1, wherein the aluminium-based filler alloy has a Si-content of at least 9.0%.

4. The shaped brazing preform according to claim 1, wherein the aluminium-based filler alloy has a Si-content of up to 13.0%.

5. The shaped brazing preform according to claim 1, wherein the aluminium-based filler alloy has a Zn content of maximum 3%.

6. The shaped brazing preform according to claim 1, wherein the aluminium-based filler alloy has a Cu content of maximum 1.75%.

7. The shaped brazing preform according to claim 1, wherein the aluminium-based filler alloy further contains up to 0.8% of one or more wetting elements selected from the group consisting of Be, Bi, Ce, La, Li, Na, Pb, Se, Sb, Sr, Th, and Y.

8. The shaped brazing preform according to claim 1, wherein the aluminium-based filler alloy further contains Bi in a range of 0.01% to 0.8%.

9. The shaped brazing preform according to claim 1, wherein the aluminium-based filler alloy is Ag-free.

10. The shaped brazing preform according to claim 1, wherein the aluminium-based alloy has having a liquidus temperature in a range of 570° C. to 585° C.

11. The shaped brazing preform according to claim 1, wherein the aluminium-based filler alloy wire is devoid of any metallic layer(s) covering substantial parts of said wire.

12. The shaped brazing preform according to claim 1, wherein the amount of brazing flux material is in a range of 10 wt. % to 40 wt. % of the shaped brazing preform.

13. The shaped brazing preform according to claim 1, wherein the shaped brazing preform has a cross-sectional diameter of up to 4 mm.

14. Use of a shaped brazing preform according to claim 1 to braze a pipe or tube of a heat exchanger.

15. A method of joining by means of brazing using an aluminium alloy brazing filler metal to form a joint between at least two base metals, preferably at least one being a pipe or tube of a heat exchanger, comprising the steps of: (a) preparing at least two base metals to be joined by brazing; (b) providing an aluminium filler alloy according to claim 1 having a liquidus temperature in a range of 560° C. to 585° C.; (c) providing a brazing flux material, (d) heating at least the joint portion of the base metals with a heating cycle; (e) joining the at least two base metals by means of brazing using the aluminium filler alloy and the brazing flux material to form the joint; and (f) cooling of the joined assembly.

16. The method according to claim 15, wherein the aluminium filler alloy brazing filler metal is provided as a continuous length of wire is a shaped brazing preform having the brazing flux material in the core of the wire according to claim 1.
